(19) United States
(12) Patent Application Publication
(10) Pub. No.: US 2023/0146465 A1
(43) Pub. Date: May 11, 2023

(54) ONBOARDING A DEVICE IN A MULTI-TENANT VIRTUAL NETWORK OF AN INDUSTRIAL NETWORK

(71) Applicant: Siemens Aktiengesellschaft, München (DE)

(72) Inventors: Reinhard Frank, München (DE); Florian Zeiger, Höhenkirchen-Siegertsbrunn (DE)

(21) Appl. No.: 17/801,933

(22) PCT Filed: Jan. 25, 2021
(86) PCT No.: PCT/EP2021/051619

§ 371 Date: Aug. 24, 2022

(30) Foreign Application Priority Data
Feb. 28, 2020 (EP) 20160186.1

(51) Int. Cl. H04L 41/0806; G05B 19/418; H04L 41/28; H04L 9/40

(52) U.S. Cl. CPC H04L 41/0806; G05B 19/41855; H04L 41/28; H04L 63/108

(57) ABSTRACT

A method for onboarding a device in a multi-tenant virtual network of an industrial network is provided. The method includes: receiving an onboarding request of the device relating to an access to the multi-tenant virtual network of the industrial network; identifying and checking the device using an authentication module of the industrial network; transmitting a configuration file to the device in the event of a positive result of the check; configuring the device according to the configuration file received by the device; checking the access authorization of the configured device at an access point of the industrial network; and, in the event of a positive result of the check, granting the device access to the multi-tenant virtual network. An industrial network configured to carry out the aforementioned method is also provided.

The present patent document is a § 371 nationalization of PCT Application Serial No. PCT/EP2021/051619, filed Jan. 25, 2021, designating the United States, which is hereby incorporated by reference, and this patent document also claims the benefit of European Patent Application No. 20160186.1, filed Feb. 28, 2020.

### TECHNICAL FIELD

The disclosure relates to a method for onboarding a device in a multi-tenant virtual network of an industrial network. Furthermore, the disclosure relates to an industrial network configured to enable efficient onboarding of devices in a multi-tenant virtual network of the industrial network.

### BACKGROUND

The disclosure relates to the development of a method in which new devices may be granted access to an existing multi-tenant virtual network (VTN) regardless of the device type or the type of network. Traditionally, devices are specifically configured before they may gain access to a specific multi-tenant virtual network, assuming the devices are appropriately authorized. The appropriately pre-configured device makes an onboarding request for the desired virtual network, its access authorization is verified and, if the result is positive, the device obtains access to the virtual network.

One disadvantage of this process is that the device must already have certain default settings at the time of delivery. The device, in particular its communication interface, must therefore be configured at a time when in many applications it would still be unclear whether or to which virtual networks the device in question should have access in the future.

In addition, a standardized mechanism for granting new devices access to an existing multi-tenant virtual network does not yet exist. Until now, each provider has offered its own method of integrating new devices into multi-tenant virtual networks.

There is therefore a need for a method and an industrial network that are flexible with regard to the devices to be integrated and the existing multi-tenant virtual networks, and which require as few specific default settings as possible on the devices.

### SUMMARY AND DESCRIPTION

This object is achieved by the method and the industrial network as described herein. The scope of the present disclosure is defined solely by the appended claims and is not affected to any degree by the statements within this summary. The present embodiments may obviate one or more of the drawbacks or limitations in the related art.

Accordingly, a method is provided for onboarding a device in a multi-tenant virtual network of an industrial network. The method includes receiving an onboarding request from the device regarding access to the multi-tenant virtual network of the industrial network, wherein the onboarding request is received in an access network of the industrial network assigned to an onboarding network of the industrial network. The method further includes identifying and verifying the device using an authentication module of the industrial network. The method further includes sending a configuration file to the device when the verification result is positive, wherein the configuration file contains data regarding the access authorization of the device to the multi-tenant virtual network. The method further includes configuring the device, in particular a communication interface of the device, according to the configuration file received from the device. The method further includes verifying the access authorization of the configured device in an access point of the industrial network and, when the verification result is positive, granting the device access to the multi-tenant virtual network.

An important aspect of the disclosure is that the device making the onboarding request does not require any specific default settings to carry out the onboarding process. In other words, the device does not need to be specially configured to gain access to the virtual multi-tenant network in question, assuming it is appropriately authorized. The device first logs into an access network of the industrial network, which is assigned to an onboarding network specially provided for onboarding new devices. Then, the identity of the requesting device is determined and, (e.g., using a database), it is verified whether the device is in principle authorized to gain access to the multi-tenant virtual network that is being requested. If the verification result is positive, the device receives a configuration package that allows the device to configure itself accordingly. The configured device may then log in directly to the multi-tenant virtual network via an access point. As in the prior art, the access authorization is verified at the access point and, if the verification result is positive, the device is granted access to the virtual network.

For the purposes of this disclosure, “onboarding” means the process by which a device, in particular a new device, is given access to a network or part of it. Onboarding may be performed once per device, e.g., when the device is requesting access to the network for the first time. Alternatively, an accessing device may repeatedly undergo the onboarding process at regular or irregular intervals. This may help to provide the security of the users, devices, data, and the entire network. However, this may also be due, for example, to a change in the access point or in the virtual network, which requires a new onboarding including a re-transmitted configuration file to the device.

A “multi-tenant virtual network” means a data and communication network that is available exclusively for a specific mandate and may connect distributed work areas of the client to each other. Defined resources may also be allocated to the multi-tenant virtual network and the network is implemented using virtual components and technologies. In the context of this patent application, a “multi-tenant virtual network” is sometimes referred to more briefly as a “virtual network” for the sake of readability, but this refers to the same thing. A multi-tenant virtual network is also referred to in the technical jargon as a “virtual tenant network” (VTN). A multi-tenant virtual network includes in particular a “multi-client virtual network” or “multi-user virtual network”. These names emphasize that more than one device may access the virtual network. A flexible, yet secure assignment of access rights to the virtual network for a plurality of devices is obviously of great interest.

The “industrial network” relates in particular to all types of industrial communication networks. Examples of this are a communication network in a production hall with a plurality of interconnected systems (devices), or an operator network of a power supply network, e.g., a wind farm with a large number of wind turbines. In particular, an industrial network has one or more industrial network nodes. An example of an industrial network node is a specific device, such as an industrial PC or a rugged computer, on which the multi-tenant virtual network is configured. Alternatively, a multi-tenant virtual network may also extend over a plurality of industrial network nodes, e.g., a plurality of PCs.

In the context of this patent application, an “access network” means a network by which a device may gain access to a specific multi-tenant virtual network. It is the access network in which onboarding requests from devices are first accepted, in other words received.

In a first alternative, the access network is open to any device. This means that a device does not have to have any default settings or meet any preconditions in order to gain access to the access network. This implements a concept of the disclosure: regardless of the device type, and regardless of how the device is configured, a device may make an appropriate onboarding request for a specific multi-tenant virtual network. To gain access to the corresponding virtual network, the device requires appropriate access authorization, but access to the access network is open to any device.

In a second alternative, access to the access network is restricted. Access to the access network may be protected, for example, with a password. This may be, for example, a “master password” that is not assigned on a device-specific basis but applies globally across the entire industrial network. Such an embodiment may be desired, for example, by the operator of a production hall who wants to design their industrial network in principle open to all onboarding devices, but also does not want to leave the access network completely open and unprotected. This allows the user to assign a global, e.g., non-device-specific password for the access network. As soon as a device or its user knows this password, the device may access the access network and its onboarding request may be received and processed.

The access network may be permanently made available for receiving on-boarding requests from devices. However, it may also be desirable to make the access network available to receive onboarding requests only for a limited period of time. This has the effect that it is absolutely guaranteed that no onboarding may take place in the times when the access network is not available, in other words, when it is not accessible. The advantage is increased security for access by devices to the multi-tenant virtual network. For example, an access network may be made available only on weekdays from 6 am to 8 pm. Or it may only be available at all for a limited time, e.g., for 12 hours from the time of creation. All relevant devices would then have to onboard during this period. This access network is then closed, and a new access network is created as necessary.

Each access network is assigned at least one onboarding network and vice versa. The onboarding network is part of the industrial network and has the function of supporting or enabling the onboarding of a device for a specific multi-tenant virtual network.

For example, the onboarding network itself may be deployed by: generating the onboarding network and an authentication module; connecting the onboarding network to the authentication module; extending the onboarding network to an access point of the industrial network; generating an access network; and connecting the access network to the onboarding network.

The authentication module may be advantageously connected to a database. This database contains information that may be used to identify and verify the identity of a device that has made an onboarding request. In particular, the authentication module may use the database to determine whether the device making the onboarding request should be granted access to the virtual network, and if so, to what extent.

An access point refers in particular to an interface between the industrial network and the onboarding device. The access point may be a piece of hardware in the form of an electronic device which, for example, is itself connected to a fixed communication network via a cable and acts as an interface for wireless communication terminals that may establish a wireless connection to the access point via a wireless adapter. However, purely virtual access points are also possible, which are implemented purely in software and nevertheless act as an interface between the onboarding devices and an industrial network.

The present disclosure relates not only to the previously described method for onboarding a device in a multi-tenant virtual network of an industrial network, but also to how such an industrial network is advantageously configured.

According to the disclosure, such an industrial network, includes at least one multi-tenant virtual network, an onboarding network, an access network assigned to the onboarding network, an authentication module, and an access point. The access network is configured in such a way that it may receive an onboarding request from a device regarding access to the multi-tenant virtual network. The authentication module is configured to identify and verify the device. The onboarding network extends to the access point. The access point is configured to verify the access authorization of the device and, if the verification result is positive, to grant the device access to the multi-tenant virtual network.

Definitions, functions, and embodiments of the individual elements of the industrial network have already been described in connection with the method for onboarding a device in a multi-tenant virtual network of an industrial network. For reasons of the necessary brevity and clarity, they are not repeated in connection with the industrial network but apply accordingly.

In practice, the industrial network may have a plurality of multi-tenant virtual networks. The industrial network therefore has a multi-tenant virtual network and at least one additional multi-tenant virtual network.

In an embodiment, the onboarding network functions as a common onboarding network for the onboarding of devices for both virtual networks, e.g., both when they are seeking access to the multi-tenant virtual network and when seeking access to the additional multi-tenant virtual network. This embodiment may also be called “as a central service” in the technical jargon.

The advantage is that only one onboarding network needs to be generated and made available. Similarly, only one access network that is assigned to the onboarding network needs to be made available (more than one access network may also optionally be assigned to a single onboarding network; this is explained in more detail below). The one onboarding network may be connected to a single authentication module. The structure is therefore lean and transparent.

However, a disadvantage of this embodiment is that if the onboarding network fails, onboarding is disrupted for all the multi-tenant virtual networks for which the common onboarding network acts as an onboarding network, e.g., it is not functional.

Therefore, in another embodiment the industrial network may have an additional onboarding network. In this case, the onboarding network advantageously performs the onboarding of devices to the multi-tenant virtual network and the additional onboarding network performs the onboarding of devices to the additional multi-tenant virtual network. If, for example, the additional onboarding network is not available, the onboarding of devices into the multi-tenant virtual network is unaffected and may be carried out independently of the non-availability of the other onboarding network. This embodiment may also be referred to as “per tenant” in the technical jargon.

If the industrial network has more than one multi-tenant virtual network, there may be either one common authentication module for all multi-tenant virtual networks or one individual authentication module for each multi-tenant virtual network. Here also, a balance is struck in practice between a lean network structure and a resilience of the entire network.

If the industrial network has more than one onboarding network and more than one authentication module, these may all be localized, for example, in one unit of the industrial network, e.g., in an industrial network node. Alternatively, the onboarding networks and/or the authentication modules may also be housed, e.g., localized, in a plurality of units of the industrial network. The first variant may also be referred to as “centralized deployment” in the technical jargon, and the second variant as “distributed deployment.”

As mentioned earlier, the industrial network may have multiple access points to which the onboarding network extends.

One motivation for deploying multiple access points may be a large physical extent of the industrial network. For example, if the industrial network includes an entire production hall with several thousand square meters of floor space, it makes sense to equip the production hall with multiple access points for onboarding devices.

On the other hand, multiple access points may also be deployed at a same physical location for different access technologies. For example, one access point may be used for wireless communication with the devices and another access point for communication with the devices via the mobile communication network (e.g., 5G).

### BRIEF DESCRIPTION OF THE DRAWINGS

The disclosure is illustrated in the following using the attached figures. These are purely schematic and show various embodiments by way of example and without limitation of the claimed scope of protection.

FIG. 1 depicts a first embodiment of the industrial network.

FIG. 2 depicts a second embodiment of the industrial network.

FIG. 3 depicts a third embodiment of the industrial network.

FIG. 4 depicts a fourth embodiment of the industrial network.

FIG. 5 depicts a fifth embodiment of the industrial network.

### DETAILED DESCRIPTION

Identical or similar elements are marked with the same reference signs in different figures. To avoid repetition, elements with the same reference signs are not named and explained separately for each figure. For these, reference may be made to the preceding figures.

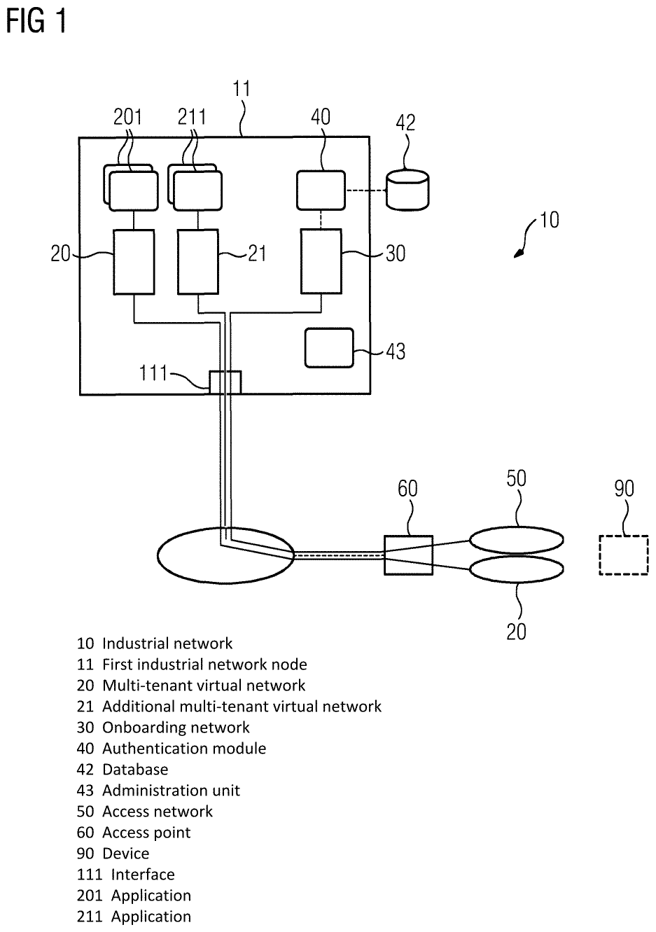

FIG. 1 (also referred to as FIG. 1) shows an industrial network 10 with a first industrial network node 11. For example, the industrial network 10 is a communication network in a production hall; the first industrial network node 11 is an industrial PC in the mentioned communication network, for example. The industrial network 10 also includes a plurality of other industrial network nodes, which for the sake of clarity are not shown in FIG. 1.

The first industrial network node 11 includes an interface 111 that represents an actual, e.g., physical, interface to the rest of the industrial network 10. By the interface 111, the first industrial network node 11 is connected in particular to an access point 60. The access point 60, in turn, acts as an interface or “anchor point” for devices 90 that are seeking access to the industrial network 10 or parts thereof.

The industrial network 10 includes a multi-tenant virtual network 20 and an additional multi-tenant virtual network 21. Applications 201 and 211, abbreviated to “apps”, run on both multi-tenant virtual networks 20, 21. The multi-tenant virtual network 20 extends up to the access point 60. A device 90 that has made an onboarding request, has received a configuration file with data relating to the authorization of the device 90 to access the multi-tenant virtual network 20, and is configured according to the configuration file received may then contact the access point 60 where, in particular, it may contact the multi-tenant virtual network 20 that extends up to that point. At the access point 60 the access authorization of the device 90 to the virtual network 20 is verified. If the verification result is positive, the device 90 is granted access to the virtual network 20.

The additional multi-tenant virtual network 21 also extends up to an access point. This may be the same access point 60 as for the multi-tenant virtual network 20, or a different access point. For the sake of clarity, the part of the additional multi-tenant virtual network 21 which is located outside the first industrial network node 11 is not shown in FIG. 1.

The first industrial network node 11 additionally includes an onboarding network 30. The onboarding network 30 is assigned an access network 50, which is located in particular at the access point 60. The onboarding network 30 is connected (or may be temporarily connected) to an authentication module 40. In turn, the authentication module may access a database 42 in order to perform the identification and verification of a device 90 making an onboarding request.

The industrial network 10 also has an administration unit 43, which is configured to generate onboarding networks. The onboarding networks may be generated by the administration unit 43 continuously, on demand, or according to a predefined schedule.

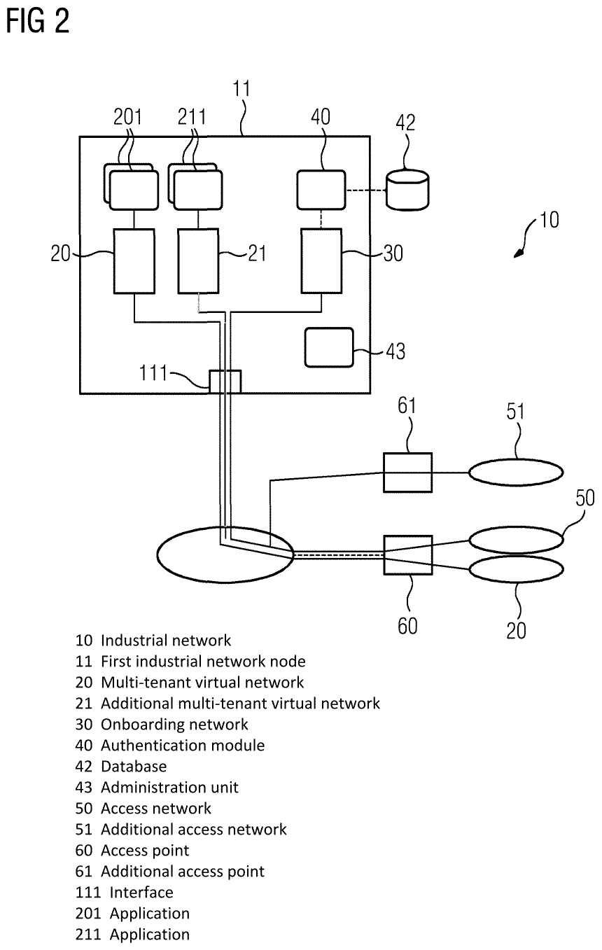

FIG. 2 (also referred to as FIG. 2) shows an industrial network 10 according to a second embodiment. In contrast to the first embodiment, in this example, the onboarding network 30 is assigned multiple access networks, the access network 50, and the additional access network 51. The access network 50 is located at the access point 60 and the additional access network 51 is located at another access point 61. There may be different reasons for the presence of multiple access points 60, 61 and access networks 50, 51. The access points 60, 61, for example, may be located a considerable distance apart, e.g., several meters apart. Alternatively, the various access points 60, 61 may also be addressed by different access technologies (e.g., WLAN, 5G, wired).

The characteristic feature of the second embodiment is that both access networks 50, 51 are assigned to a common onboarding network 30 and that onboarding requests, regardless of the access network 50, 51 at which they are received, are verified by a common authentication module 40. Such a structure may also be called an “as a central service” onboarding mechanism.

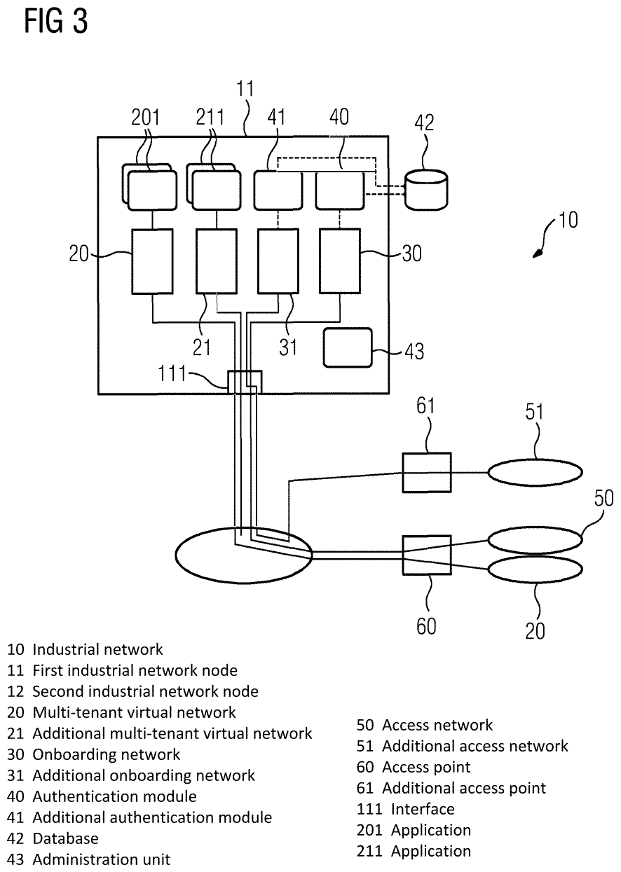

FIG. 3 (also referred to as FIG. 3) shows an industrial network 10 according to a third embodiment. In this example, the industrial network 10, more precisely the first industrial network node 11, has one onboarding network for each multi-tenant virtual network: the onboarding network 30 for the multi-tenant virtual network 20 and the additional onboarding network 31 for the additional multi-tenant virtual network 21. Each onboarding network 30, 31 is assigned an individual access network 50, 51 in an individual access point 60, 61. Also, each onboarding network 30, 31 is, or at least may be, connected to an individual authentication module 40, 41. If one access network is not available (intentionally or unintentionally), this does not affect the onboarding of a device 90 to the other access network/onboarding network and ultimately to the other virtual network. Such a structure may also be called a “per tenant network” onboarding mechanism.

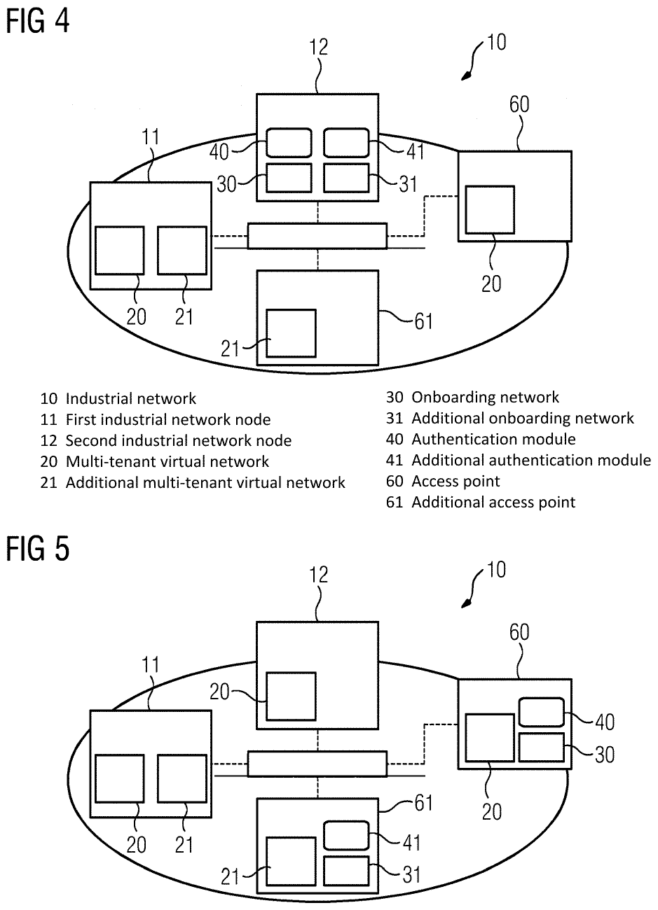

FIG. 4 (also referred to as FIG. 4) shows an industrial network 10 according to a fourth embodiment. In contrast to the previous exemplary embodiments, here two industrial network nodes are shown: a first industrial network node 11 and a second industrial network node 12. The two industrial network nodes 11 and 12 represent, for example, two different industrial PCs in a communication network. The industrial network 10 has two multi-tenant virtual networks 20, 21. Both virtual networks 20, 21 are located on an industrial network node, in the example shown on the first industrial network node 11. The industrial network 10 also has two onboarding networks 30, 31 and two authentication modules 40, 41. The two onboarding networks 30, 31 and the two authentication modules 40, 41 are all located on the second industrial network node 12. Thus, a single unit, namely the second industrial network node 12, houses all the onboarding networks 30, 31 and authentication modules 40, 41. Such a structure may also be referred to as “centralized deployment”.

In contrast, the fifth exemplary embodiment shows a structure that may be called “distributed deployment”. Here, the onboarding network 30 and the authentication module 40 for the multi-tenant virtual network 20 are located on a first unit, namely the (first) access point 60, and the additional onboarding network 31 and the additional authentication module 41 for the additional multi-tenant virtual network 21 are located on a second unit, namely the additional access point 61.

The fifth exemplary embodiment shown in FIG. 5 (also referred to as FIG. 5) also shows the variant in which a multi-tenant virtual network may extend over a plurality of industrial network nodes. For example, the virtual network 30 is located on both the first industrial network node 11 and on the second industrial network node 12. FIG. 5 also illustrates that an onboarding network does not necessarily have to be localized on an industrial network node. In FIG. 5, the onboarding network 30, 31 and the authentication module 40, 41 are located on the access point 50 or the additional access point 51 for both the multi-tenant virtual network 20 and the additional multi-tenant virtual network 21.

In summary, it may be concluded that the concept of the onboarding of devices in a multi-tenant virtual network of an industrial network may be applied extremely flexibly to the specific configuration of the relevant industrial network.

It is to be understood that the elements and features recited in the appended claims may be combined in different ways to produce new claims that likewise fall within the scope of the present disclosure. Thus, whereas the dependent claims appended below depend on only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

### LIST OF REFERENCE SIGNS

10 industrial network

11 first industrial network node

111 interface (of the first industrial network node)

12 second industrial network node

20 multi-tenant virtual network

201 application

21 additional multi-tenant virtual network

211 application

30 onboarding network

31 additional onboarding network

40 authentication module

41 additional authentication module

42 database

43 administration unit

50 access network

51 additional access network

60 access point

61 additional access point

90 device

1. A method for onboarding a device in a multi-tenant virtual network of an industrial network, comprising:
receiving an onboarding request from the device regarding access to the multi-tenant virtual network of the industrial network, wherein the onboarding request is received in an access network of the industrial network assigned to an onboarding network of the industrial network;
identifying and verifying the device using an authentication module of the industrial network;
sending a configuration file to the device when a he verification result is positive, wherein the configuration file comprises data regarding an access authorization of the device to the multi-tenant virtual network;
configuring the device according to the configuration file;
verifying the access authorization of the device in an access point of the industrial network; and
granting the device access to the multi-tenant virtual network when the verification result is positive.

2. The method of claim 1, further comprising:
deploying the onboarding network, wherein the deploying comprises:
generating the onboarding network and the authentication module;
connecting the onboarding network to the authentication module;
extending the onboarding network to the access point of the industrial network;
generating the access network;
connecting the access network to the onboarding network.

3. The method of claim 1, wherein the access network is only made available to receive onboarding requests for a limited period of time.

4. An industrial network comprising:
a multi-tenant virtual network;
an onboarding network;
an access network assigned to the onboarding network, wherein the access network is configured to receive an onboarding request from a device regarding access to the multi-tenant virtual network;
an authentication module configured to identify and verify the device; and
an access point to which the onboarding network extends and which is configured to verify an access authorization of the device and grant the device access to the multi-tenant virtual network when a verification result is positive,
wherein a configuration file comprises data regarding the access authorization of the device to the multi-tenant virtual network, and
wherein the device is configured according to the configuration file.

5. The industrial network of claim 4, wherein the industrial network comprises at least one additional multi-tenant virtual network.

6. The industrial network of claim 5, wherein the onboarding network is configured to act as a common onboarding network for onboarding devices to the multi-tenant virtual network and to the additional multi-tenant virtual network.

7. The industrial network of claim 5, wherein the industrial network comprises at least one additional onboarding network,
wherein the onboarding network is configured to onboard devices to the multi-tenant virtual network, and
wherein the additional onboarding network is configured to onboard devices to the additional multi-tenant virtual network.

8. The industrial network of claim 7, wherein the industrial network comprises at least one additional authentication module configured to identify and verify a device that has made an onboarding request regarding access to the additional multi-tenant virtual network.

9. The industrial network of claim 8, wherein one unit in the industrial network houses the onboarding network, the at least one additional onboarding network, the authentication module, and the at least one additional authentication module.

10. The industrial network of claim 8, wherein the onboarding network and the at least one additional onboarding network and/or the the authentication module and the at least one additional authentication module are housed in a plurality of units of the industrial network.

11. The industrial network of claim 4, wherein the industrial network comprises at least one additional access point, and
wherein the onboarding network extends to the access point and the at least one additional access point.

12. The industrial network of claim 11, wherein the access point and the at least one additional access point are spatially separated by several meters.

13. The industrial network of claim 11, wherein the access point and the at least one additional access point are configured for different access technologies.

14. The method of claim 1, wherein a communication interface of the device is configured according to the configuration file.
